(19) United States
(12) Patent Application Publication
(10) Pub. No.: US 2006/0097981 A1
(43) Pub. Date: May 11, 2006

(54) Liquid crystal display and driving method thereof

(76) Inventors: Chul-Woo Park, Suwon-si (KR); Tae-Soo Kim, Suwon-si (KR)

Correspondence Address: CHRISTIE, PARKER & HALE, LLP, PO BOX 7068, PASADENA, CA, 91109-7068, US

(21) Appl. No.: 11/255,307

(22) Filed: Oct. 20, 2005

(30) Foreign Application Priority Data
Nov. 10, 2004 (KR) 10-2004-0091326

(51) Int. Cl. G09G 3/36

(52) U.S. Cl. 345/102

(57) ABSTRACT

An LCD and a driving method thereof. A plurality of scan lines are divided into first-group scan lines and second-group scan lines. A scan signal is sequentially applied to the first-group scan lines in a first direction, and a scan signal is then sequentially applied to the second-group scan lines in a second direction. The first group includes odd scan lines and the second group includes even scan lines. Therefore, the brightness difference between the first and last lines can be reduced.

### CROSS-REFERENCE TO RELATED APPLICATION

This application claims priority to and the benefit of Korean Patent Application No. 10-2004-0091326 filed in the Korean Intellectual Property Office on Nov. 10, 2004, the entire content of which is incorporated herein by reference.

### Field of the Invention

The present invention relates to a liquid crystal display (LCD) and a driving method thereof, and in particular, to an LCD using a field sequential driving method.

### BACKGROUND

As personal computers and televisions etc. have become more lightweight and thin, the demand for lightweight and thin display devices has increased. According to such requirements, flat panel displays such as liquid crystal displays (LCD) are increasing in popularity over cathode ray tubes (CRT).

An LCD is a display device used to display a desired video signal by applying electric fields to liquid crystal materials having an anisotropic dielectric constant and injected between two substrates. The strength of electric fields is controlled so as to control the amount of light transmitting through a substrate from an external light source (back light).

The LCD is representative of portable flat panel displays, and TFT-LCDs using thin film transistors (TFT) as switches are mainly used.

Each pixel in the TFT-LCD can be modeled with capacitors having liquid crystal as a dielectric substance, such as a liquid crystal capacitor. Pixel circuits are formed on a plurality of pixel areas defined by crossing of a plurality of data lines and a plurality of scan lines, and the pixel circuit includes TFTs each having a source and a gate coupled to each other and a liquid crystal capacitor coupled between a drain of the TFT and a common voltage.

The liquid crystal display operation can be classified into two methods: a color filter method and a field sequential driving method, based on methods of displaying color images.

A liquid crystal display of a color filter method has color filter layers including three primary colors (red R, green G, and blue B) in one of two substrates, and displays a desired image by controlling an amount of light transmitting through the color filter layer.

The liquid crystal display device displaying color using a single light source and three color filter layers needs pixels respectively corresponding to each R, G, and B subpixels, thus at least three times the number of pixels are needed compared to displaying black and white. Therefore, fine manufacturing techniques are required to produce high-resolution video images.

The field sequential driving type of liquid crystal display sequentially and periodically turns on each independent light source of R, G, and B, and adds synchronized color signals corresponding to each pixel based on the lighting period to obtain full colors. That is, one pixel is not divided into R, G, and B subpixels, and light of three primary colors output from R, G, and B back lights is sequentially displayed in a time-division manner so that the color images are displayed by means of the afterimage effect of the eyes.

An operation of the field sequential driving type of liquid crystal display will now be described with reference to FIGS. 1 and 2. FIG. 1 shows a driving waveform diagram of a conventional field sequential driving type of liquid crystal display, and FIG. 2 shows liquid crystal transmittivity of the driving waveform of FIG. 1 where the liquid crystal corresponds to a liquid crystal capacitor.

A frame is divided into an R field, a G field, and a B field and is then driven. When a scan signal is applied to a plurality of scan lines S1 to Sn to turn on the TFT for each field, a data voltage supplied to corresponding data lines D1 to Dm is applied to each pixel electrode (not illustrated) through the TFT.

An electric field corresponding to a difference between the common voltage and a pixel voltage applied to the pixel electrode is applied to the liquid crystal capacitor, so that the light is transmitted with transmittivity corresponding to the intensity of the electric field. The data voltage is illustrated in FIG. 1 to be applied to the jth data line Dj from among the data lines D1 to Dm in one of R, G, and B fields. In general, the liquid crystal is differently arranged when a voltage is applied to the liquid crystal, and the optical transmittivity is varied depending on the arrangement of the liquid crystal. The optical transmittivity represents a transmittivity of light when the light is transmitted through the liquid crystal. That is, optical transmittivity indicates a torsion degree that allows a liquid crystal to transmit light.

However, when digital driving is applied, no normal state for maintaining the optical transmittivity of liquid crystal exists because of a characteristic of the field sequential driving type of LCD. Hence, the optical transmittivity is not maintained and a difference thereof is generated in a time delay format as shown in FIG. 2 when a scan signal is sequentially applied to the scan lines and the light of backlight LED is applied to all scan lines according to the driving method of FIG. 1. Brightness deviation occurs according to positions on the liquid crystal display panel.

The information disclosed in this section is only for enhancement of understanding of the art related to the invention, and therefore, unless explicitly described to the contrary, it should not be taken as an acknowledgement or any form of suggestion that this information forms prior art that is already known in this country to a person of ordinary skill in the art.

### SUMMARY

In one embodiment of the present invention, a liquid crystal display comprises a plurality of data lines, a plurality of scan lines, a first scan driver, a second scan driver, and a light source. The data lines, provided in a predetermined direction, transmit a data voltage for an image. The scan lines provided to cross the data lines are divided into first-group scan lines and second-group scan lines. The first scan driver sequentially applies a first scan signal to the first-group scan lines in a first direction, the second scan driver sequentially applies a second scan signal to the second-group scan lines in a second direction after the first scan driver has sequentially applied the first scan signal to the first-group scan lines. The light source outputs a first light, a second light, and a third light to a plurality of pixel areas defined by crossing of the data lines and the scan lines.

The first group includes odd scan lines and the second group includes even scan lines. The second direction corresponds to the first direction or is opposite to the first direction.

In other embodiments, the first and second scan drivers respectively comprise first-group latches and second-group latches. The first-group latches are established to input an output signal of a former latch to a latter latch, and shift the output signal of the former latch and output the same according to a first control signal. The second-group latches are established to input an output signal of a former latch to a latter latch, and shift the output signal of the former latch and output the same according to a second control signal.

The first and second control signals may determine a shift direction of the output signal. The first-group latches may output a scan signal to odd scan lines and the second-group latches may output a scan signal to even scan lines. The first-group latches may be separated from the second-group latches.

In other embodiments of the present invention, a method for driving a liquid crystal display is provided including a plurality of data lines for transmitting a data voltage for an image, a plurality of scan lines for transmitting a scan signal, and a plurality of pixel areas defined by crossing of the data lines and the scan lines. A frame is divided into a first field for applying a first light, a second field for applying a second light, and a third field for applying a third light, the first, second, and third fields are sequentially driven, and the scan lines include a first group and a second group. In one embodiment, in at least one of the first, second, and third fields, a first scan signal is sequentially applied to the first-group scan lines in a first direction, and a second scan signal is sequentially applied to the second-group scan lines in a second direction after the first scan signal has sequentially been applied to the first-group scan lines in the first direction.

The first group can include odd scan lines and the second group can include even scan lines. The second direction corresponds to the first direction, or is opposite to the first direction.

### BRIEF DESCRIPTION OF THE DRAWINGS

FIG. 1 shows a conventional LCD driving waveform diagram;

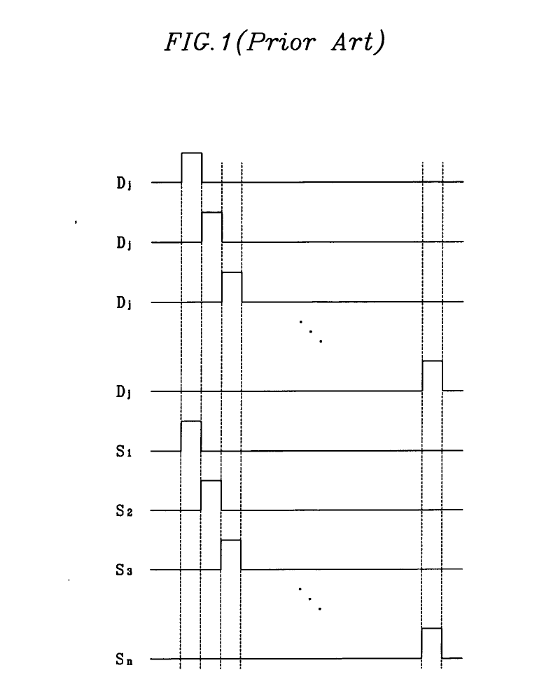

FIG. 2 shows liquid crystal transmittivity of the driving waveform of FIG. 1;

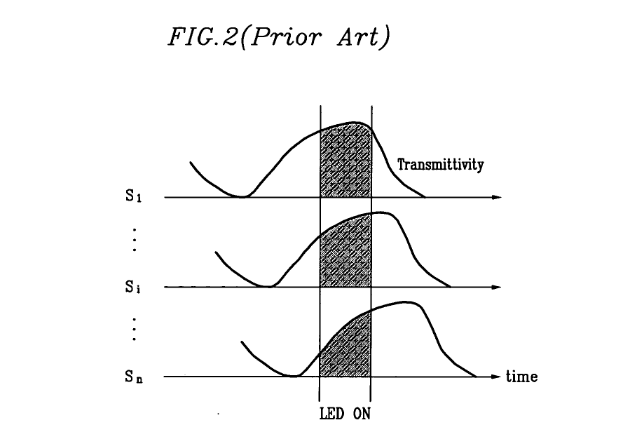

FIG. 3 shows an LCD according to one embodiment of the present invention;

FIG. 4 shows a pixel circuit diagram of an LCD according to an embodiment of the present invention;

FIG. 5 shows a driving waveform diagram of an LCD according to one embodiment of the present invention;

FIG. 6 shows a scan driver of an LCD for generating the driving waveform of FIG. 5;

FIG. 7 shows a driving waveform diagram of an LCD according to another embodiment of the present invention; and

FIGS. 8(a) to FIG. 8(c) show comparative efficiency tables of the driving methods according to the conventional driving methods and those of the embodiments shown in FIGS. 5 and 7.

### DETAILED DESCRIPTION

In the following detailed description, embodiments of the present invention are shown and described, by way of illustration. As those skilled in the art would recognize, the described embodiments may be modified in various ways, all without departing from the spirit or scope of the present invention. Accordingly, the drawings and description are to be regarded as illustrative in nature, rather than restrictive.

A liquid crystal display (LCD) and driving method thereof according to exemplary embodiments of the present invention will be described with reference to drawings.

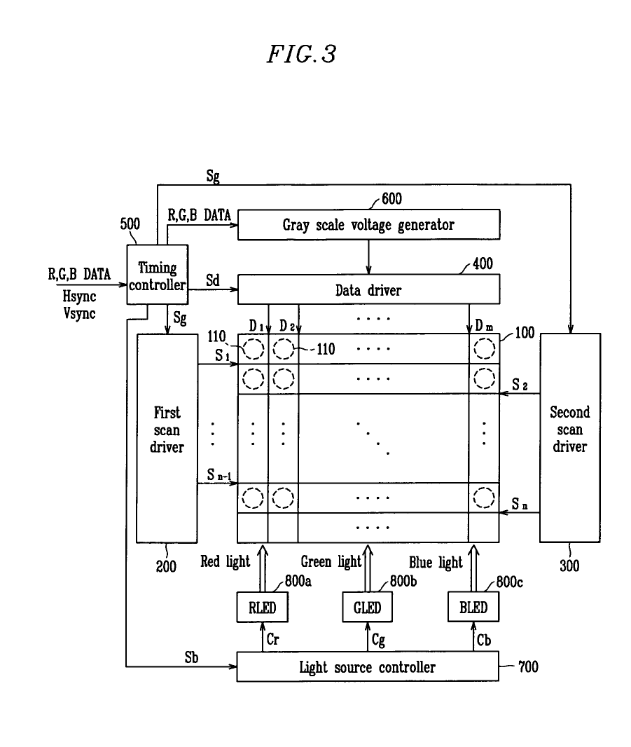

A structure of the LCD will now be described with reference to FIG. 3, which shows an LCD according to one embodiment of the present invention.

As shown, the LCD includes a liquid crystal display panel 100, a first scan driver 200, a second scan driver 300, a data driver 400, a timing controller 500, a gray scale voltage generator 600, a light source controller 700, and light emitting diodes 800a, 800b, and 800c.

The liquid crystal display panel 100 includes a plurality of data lines D1 to Dm in the vertical direction, and a plurality of scan lines S1 to Sn in the horizontal direction. A plurality of pixel circuits 110 are formed at the crossings of the scan lines and the data lines. The scan lines S1 to Sn transmit scan signals for selecting pixel circuits to the pixel circuits 110, and are divided into first-group scan lines and second-group scan lines. The first group includes odd scan lines, and the second group includes even scan lines. The data lines D1 to Dm transmit data voltages corresponding to gray scale data to the pixel circuits 110 which are formed on pixel areas defined by the data lines D1 to Dm and the scan lines S1 to Sn.

The first scan driver 200 sequentially applies a scan signal to the first-group scan lines, and the second scan driver 300 then sequentially applies a scan signal to the second-group scan lines.

The data driver 400 applies a data voltage to the data lines.

The timing controller 500 receives grayscale data signals (RGB DATA), a horizontal synchronization signal Hsync, and a vertical synchronization signal Vsync from a graphic controller (not illustrated) to transmit control signals Sg, Sd, and Sb to the first and second scan drivers 200 and 300, the data driver 400, and the light source controller 700, and transmits gray scale data (RGB DATA) to the gray scale voltage generator 600.

The gray voltage generator 600 generates a gray voltage corresponding to the grayscale data and transmits the same to the data driver 400. The light source controller 700 controls turn-on timing of the light emitting diodes 800a, 800b, and 800c. The light emitting diodes 800a, 800b, and 800c output light corresponding to the red, green, and blue to the liquid crystal display panel 100. The light emitting diodes 800a, 800b, and 800c are used as backlight, but the exemplary embodiment is not restricted to this.

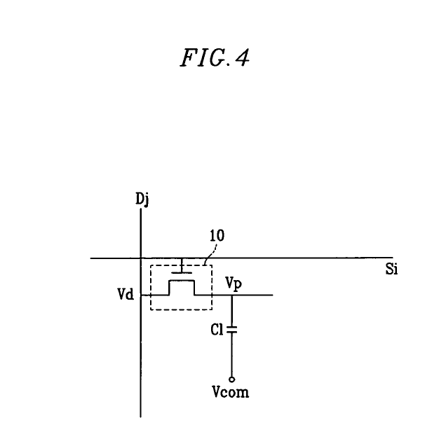

FIG. 4 shows a pixel circuit diagram of an LCD according to an exemplary embodiment of the present invention where the pixel circuit is coupled to the j^{th} data line Dj and the i^{th} scan line S1. As shown, the pixel circuit 110 includes a TFT 10 and a liquid crystal capacitor C1. A source electrode and a gate electrode of the TFT 10 are coupled to the data line Dm and the scan line Sn, and a data voltage of Vd supplied to the data line Dj is applied to a pixel electrode (not shown).

The liquid crystal capacitor Cl is coupled between a drain electrode of the TFT 10 and the common voltage of Vcom to transmit light with transmittivity corresponding to the intensity of the electric field corresponding to a difference between the common voltage of Vcom and a pixel voltage of Vp applied to the pixel electrode.

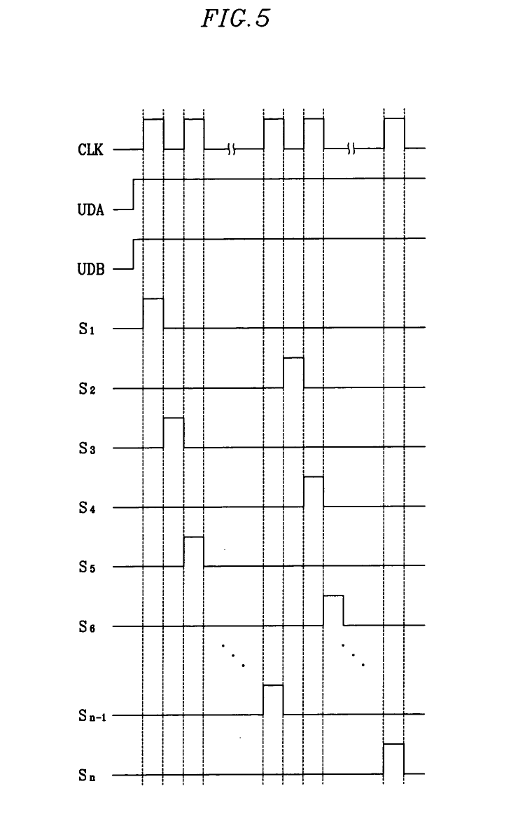

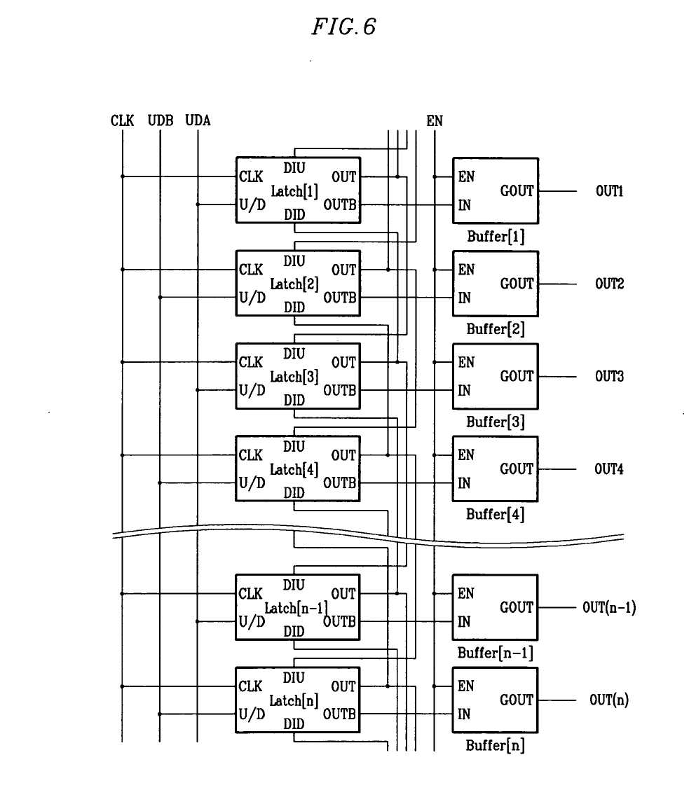

A method for eliminating brightness deviation on the liquid crystal display panel 100 will be described with reference to FIGS. 5 and 6.

FIG. 5 shows a driving waveform diagram of an LCD according to one embodiment of the present invention, and FIG. 6 shows a scan driver of an LCD for generating the driving waveform of FIG. 5 where n is given to be an even number.

As shown in FIG. 6, the first and second scan drivers 200 and 300 respectively include a plurality of latches (Latch[1] to Latch[n]) and a plurality of buffers (Buffer[1] to Buffer[n]).

The latches (Latch[1] to Latch[n−1]) latch clock signal CLK and output the same to shift scan pulses. The latches (Latch[1] to Latch[n−1]) include odd latches (Latch[1] to Latch[n−1]) in the vertical direction, and even latches (Latch[2] to Latch[n]) in the horizontal direction. An output signal of the i^{th} latch (Latch[i]) is input to the (i+2)th latch (Latch[i+2]), and an output signal of the (i+1)^{th} latch (Latch[i+1]) is input to the (i+3)th latch (Latch[i+3]). In this instance, “i” is an integer from 1 to n, the odd latches (Latch[1] to Latch[n−1]) are defined to be first-group latches, and the even latches (Latch[2] to Latch[n]) are defined to be second-group latches.

An Up Down A (UDA) signal and an Up Down B (UDB) signal determine a shift direction of the scan pulse applied to the scan line. The UDA signal controls the direction of the scan pulse output by the first-group latches, and the UDB signal controls the direction of the scan pulse output by the second-group latches. That is, the Digital Input Up (DIU) is established to be an input terminal of the latch to shift the scan pulse in the downward direction when the UDA and UDB signals are high, and the Digital Input Down (DID) is established to be an input terminal of the latch to shift the scan pulse in the upward direction when the UDA and UDB signals are low. In this instance, the upward direction represents the direction defined to be from the top to the bottom of the liquid crystal display panel 100.

Output terminals (OUTB) of the latches (Latch[1] to Latch[n−1]) output inverted scan pulses to the buffers (Buffer[1] to Buffer[n]). The buffers (Buffer[1] to Buffer[n]) invert the signals provided by the output terminals (OUTB) thereof, amplify the inverted signals, and output signals (OUT[1] to OUT[n]) as scan signals to the scan lines.

The above-described latch circuits are easily realizable by a simple logic circuit, and the same can also be implemented by other types of logic circuits in addition to the latch circuit of FIG. 6.

In a like manner, scan signals with pulses of a high level are sequentially generated to the first-group scan lines, and scan signals with pulses of a high level are sequentially generated to the second-group scan lines as shown in FIG. 5.

An operation of the LCD will now be described with reference to FIG. 5.

A frame is divided into an R field, a G field, and a B field, each of which then turns on the TFT 10 when a scan signal is sequentially and downwardly applied to the first-group scan lines. A corresponding data voltage is applied to the data line and is then applied to the pixel electrode through the TFT 10. After the scan signal is applied to the last scan line of the first-group scan lines, a scan signal is sequentially and downwardly applied to the second-group scan lines and the TFT 10 is turned on so that the corresponding data voltage is applied to the data line and is then applied to the pixel electrode through the TFT 10. One of the R field, G field, and B field is given for ease of description in FIG. 5.

Accordingly, since images corresponding to red, green, and blue are sequentially displayed in the R field, G field, and B field, the images are combined because of a visual afterimage effect and color images for one frame are thus displayed.

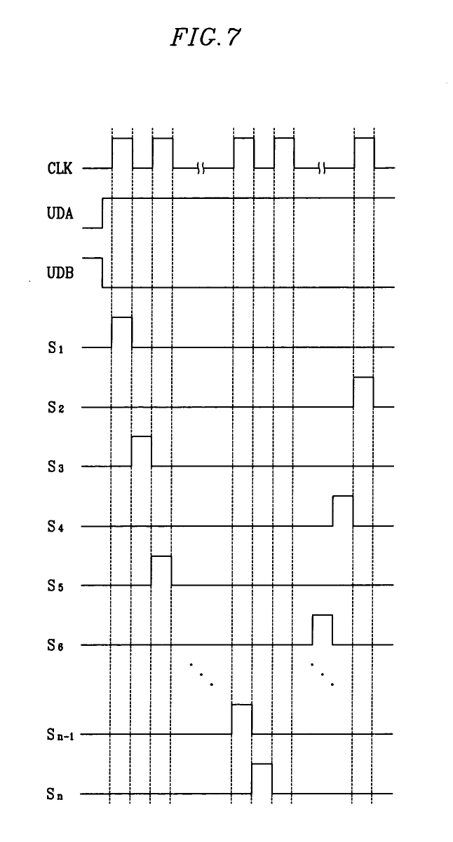

FIG. 7 shows a driving waveform diagram of an LCD according to another embodiment of the present invention.

As shown, scan signals are sequentially and downwardly applied to the first-group scan lines, and scan signals are then sequentially and downwardly applied to the second-group scan lines. The direction of the scan signals is controllable by controlling the UDB signal as described above.

It is difficult in general for a person to fully recognize the brightness difference between adjacent lines, and it is easy for the person to recognize the brightness difference between lines with a predetermined gap (e.g., the first scan line and the last scan line). Therefore, the brightness deviation can be substantially reduced by reducing the brightness difference between lines with a predetermined gap as described in these embodiments, compared to the prior art.

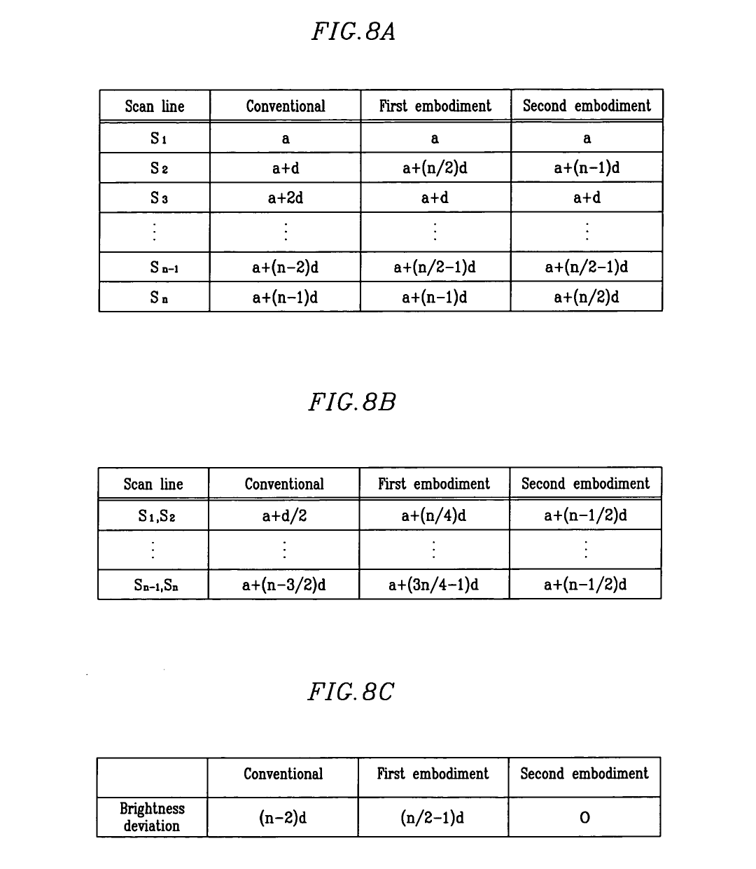

FIG. 8(a) to FIG. 8(c) show efficiency of the driving methods according to the embodiments shown in FIGS. 5 and 7. The brightness of the first scan line S1 is designated “a,” the number of scan lines of the liquid crystal display panel 100 is designated “n,” a brightness difference generated at a pixel area defined by a scan line and a data line when a scan signal is applied is designated “d,” and the brightness difference is constant.

The brightness difference generated at the pixel area is shown in FIG. 8(a) when a scan signal is sequentially applied to the scan lines. The table of FIG. 8(b) is obtained from that of FIG. 8(a) on the assumption that the mixed colors generated at the adjacent scan line is displayed as an average of brightness.

The brightness difference between the first scan line S1 and the last scan line Sn is shown as FIG. 8(c) from FIG. 8(b).

As can be seen from FIGS. 8(a) to 8(c), the brightness difference between the first scan line S1 and the last scan line Sn in the driving method according to the first embodiment is reduced to half the conventional driving method, and the brightness difference therebetween in the driving method according to the second embodiment is eliminated.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

For example, the exemplary embodiments are applicable to the color filter type LCD as well as the field sequential driving type LCD. In addition, the scan lines can be divided into more than two groups.

Therefore, brightness deviation is eliminated on the LCD panel by dividing the scan lines into the first group having odd scan lined and the second group having even scan lines, and applying the scan signal to the first-group scan lines and the same then to the second-group scan lines.

What is claimed is:

1. A liquid crystal display comprising:
a plurality of data lines provided in a predetermined direction for transmitting a data voltage for an image;
a plurality of scan lines provided to cross the data lines and divided into first-group scan lines and second-group scan lines;
a first scan driver for sequentially applying a first scan signal to the first-group scan lines in a first direction;
a second scan driver for sequentially applying a second scan signal to the second-group scan lines in a second direction after the first scan driver has sequentially applied the first scan signal to the first-group scan lines; and
a light source for outputting a first light, a second light, and a third light to a plurality of pixel areas defined by the crossing of the data lines and the scan lines.

2. The liquid crystal display of claim 1, wherein the first group includes odd scan lines and the second group includes even scan lines.

3. The liquid crystal display of claim 2, wherein the second direction corresponds to the first direction.

4. The liquid crystal display of claim 2, wherein the second direction is opposite to the first direction.

5. The liquid crystal display of claim 1, wherein the first scan driver comprises:
first-group latches being established to input an output signal of a former latch to a latter latch, and shifting the output signal of the former latch and outputting the same according to a first control signal; and the second scan driver comprises:
second-group latches being established to input an output signal of a former latch to a latter latch, and shifting the output signal of the former latch and outputting the same according to a second control signal.

6. The liquid crystal display of claim 5, wherein the first and second control signals determine a shift direction of the output signal.

7. The liquid crystal display of claim 6, wherein the first-group latches output a scan signal to odd scan lines, and the second-group latches output a scan signal to even scan lines.

8. The liquid crystal display of claim 7, wherein the first-group latches are separated from the second-group latches.

9. The liquid crystal display of claim 5, wherein the first light, the second light, and the third light are red, green, and blue, respectively.

10. A method for driving a liquid crystal display including a plurality of data lines for transmitting a data voltage for an image, a plurality of scan lines for transmitting a scan signal, and a plurality of pixel areas defined by respective data lines crossing respective scan lines, wherein a frame is divided into a first field for applying a first light, a second field for applying a second light, and a third field for applying a third light, the first field, the second field and the third field are sequentially driven, and the scan lines include a first group and a second group, the method comprising:
in at least one of the first field, the second field and the third field,
sequentially applying a first scan signal to the first-group scan lines in a first direction; and
sequentially applying a second scan signal to the second-group scan lines in a second direction after sequentially applying the first scan signal to the first-group scan lines in the first direction.

11. The method of claim 10, wherein the first group includes odd scan lines and the second group includes even scan lines.

12. The method of claim 11, wherein the second direction corresponds to the first direction.

13. The method of claim 11, wherein the second direction is opposite to the first direction.

14. The method of claim 10, further comprising:
providing a first-group latches and a second-group latches;
inputting an output signal of a former latch of the first-group latches to a latter latch of the first-group latches; and shifting the output signal of the former latch of the first-group latches and outputting the same according to a first control signal;
inputting an output signal of a former latch of the second-group latches to a latter latch of the second-group latches, and shifting the output signal of the former latch of the second-group latches and outputting the same according to a second control signal.

15. The method of claim 14, wherein the output signal of the former latch of the first-group latches or the second-group latches is determined by the first or second control signals.

16. The method of claim 15, wherein the first-group latches output a scan signal to odd scan lines, and the second-group latches output a scan signal to even scan lines.

17. The method of claim 16, wherein the first-group latches are separated from the second-group latches.

18. The method of claim 10, wherein the first light is red, the second light is green, and the third light is blue.
